(19) United States
(12) Patent Application Publication
(10) Pub. No.: US 2026/0369177 A1
(43) Pub. Date: Nov. 19, 2026

(54) VIRTUAL REALITY TRAINING SIMULATOR

(71) Applicant: Gregory Construction Services, Inc., Columbus, MS (US)

(72) Inventors: Aaron Coy Gregory, Gurley, AL (US); Keith Denton, Madison, AL (US); Stephen Hess, Denton, TX (US); Mike Christian, Denton, TX (US)

(21) Appl. No.: 19/676,501

(22) Filed: May 13, 2026

Related U.S. Application Data
(60) Provisional application No. 63/805,105, filed on May 13, 2025.

(51) Int. Cl. G09B 9/052; G02B 27/01; G06F 3/01; G09B 9/05

(52) U.S. Cl. CPC G09B 9/052; G02B 27/017; G06F 3/011; G09B 9/05

(57) ABSTRACT

A system for simulated training in a virtual reality training simulator may include first hardware, a virtual reality headset, and a processing device. The first hardware may be associated with a first operation. The first hardware may be configured to generate inputs based on a user interaction of a user with the first hardware. The processing device may facilitate an interface between the first hardware and the virtual reality headset. The virtual reality headset may display a virtual environment for the user to interact with using the inputs generated by the first hardware. The virtual environment may correspond to the first operation. The virtual reality headset may also be operable to cause a report to be automatically generated associated with a performance of the user relative to the first operation in the virtual environment.

### CROSS REFERENCE TO RELATED APPLICATIONS

This U.S. Patent Application claims priority to U.S. Provisional Patent Application No. 63/805,105, titled “VIRTUAL REALITY TRAINING SIMULATOR,” and filed on May 13, 2025, the disclosure of which is hereby incorporated by reference in its entirety.

### TECHNICAL FIELD

This disclosure relates to training using simulation, and more specifically, to a virtual reality training simulator.

### BACKGROUND

Unless otherwise indicated herein, the materials described herein are not prior art to the claims in the present application and are not admitted to be prior art by inclusion in this section.

Training equipment operators is oftentimes expensive and/or time consuming. For example, to train an equipment operator on a new machine, a machine may first need to be made available (which may slow production and/or may incur other costs) for training, which may limit how much the machine may be used to further various projects. In some instances, the machines that may be used for an operator to train on may be inherently expensive. Alternatively, or additionally, the machines used for training may be damaged as part of the training (e.g., due to a lack of knowledge of the equipment operator) which may further add to expenses associated with training an equipment operator using a machine.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

In an example embodiment, a system for simulated training in a virtual reality training simulator may include first hardware, a virtual reality headset, and a processing device. The first hardware may be associated with a first operation. The first hardware may be configured to generate inputs based on a user interaction of a user with the first hardware. The processing device may facilitate an interface between the first hardware and the virtual reality headset. The virtual reality headset may display a virtual environment for the user to interact with using the inputs generated by the first hardware. The virtual environment may correspond to the first operation. The virtual reality headset may also be operable to cause a report to be automatically generated associated with a performance of the user relative to the first operation in the virtual environment.

In another embodiment, a system for simulated training in a virtual reality training simulator may include a modular frame assembly, a virtual reality headset, and a processing device. The modular frame assembly may include a base assembly defining a seating bay. The modular frame assembly may also include a pedal assembly coupled to the base assembly, which may include a pedal module. The modular frame assembly may further include at least one control arm assembly coupled to the base assembly. The modular frame assembly may also include equipment specific control modules coupled to the control arm assembly. The processing device may be communicatively coupled to the pedal module, the equipment specific control modules, and the virtual reality headset. The virtual reality headset may be configured to display a simulated environment within the virtual reality headset. The virtual reality headset may also be configured to obtain a user input from the pedal module and the equipment specific control modules and cause a corresponding operation to occur in the simulated environment.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example environment for a virtual reality training simulator;

FIG. 2 illustrates a perspective view of an example virtual reality training simulator;

FIGS. 3A and 3B illustrate first-person perspective views of a virtual reality training simulator in use;

FIGS. 4A, 4B, and 4C illustrate first-person perspective views of a virtual reality training simulator in use;

FIG. 5 illustrates a perspective view of an example virtual reality training simulator and a corresponding case; and

FIG. 6 illustrates an example computing device.

### DETAILED DESCRIPTION

Training machine operators, such as operators of excavators, fork lifts, dozers, dump trucks, and/or wheel loaders, to learn new skills and/or to handle different machines may be time consuming and/or expensive. For example, a machine may be set aside for training purposes, which may reduce the availability of the machine to engage in operations and/or the machine may become damaged during training, especially due to the machine operator being less experienced in using the machine. In some instances, obtaining more skilled machine operators (more skilled in terms of depth of experience and/or breadth of operations related to one or more machines) may be beneficial, as skilled machine operators may perform a broad set of operations and/or may be able to operate a wide variety of machines.

In some instances, a virtual reality (VR) training simulator may be utilized to offer a machine operator training in a new skill and/or to use a new piece of machinery, while not limiting the production of the machine as a real piece of machinery may not be needed for the machine operator to train on. As such, the VR training simulator may reduce downtime of a machine, expenses associated with training using a machine, and/or potential repairs to be made to the machine caused by improper use during training.

In some instances, virtual training may enable equipment operators, laborers, and/or safety personnel to develop skills and situational awareness in the safety of an enclosed office or training room prior to operations at a worksite. The virtual training may further enable proficiency training and/or skills assessment for new and experienced equipment operators alike without unnecessary wear and tear on actual equipment, burning expensive fuel, and risking damage or injuries due to workplace accidents.

An adjustable, modular frame may be designed for portability and versatility and may be augmented by joysticks, levers, pedals, and/or switches that may be representative of live equipment controls, such that various equipment types may be emulated. A VR headset may be used to create an immersive environment, which may replicate an actual in-cab environment, including instrumentation and/or automation systems. For a particular machine simulation that may be loaded into a VR headset, training instruction may be given through a combination of on-line lesson guides, voiceover commands, and/or AI-controlled personnel characters in the VR environment, guiding the trainee through a series of tasks. Assessment modules may follow each training lesson to determine the trainee’s proficiency in the training tasks assigned. Training can occur either as an individual endeavor, or multiple VR headsets may be connected in multi-user mode for interactive scenarios involving, for example, a loader and a dump truck coordinating positions for loading, or a spotter giving signals and instruction to an excavator operator during a trenching or lifting operation.

The modularity and/or portability of the modular frame and/or the minimal weight and space for the VR headset may facilitate many (e.g., a dozen or more) separate construction (e.g., earthmoving, material moving, etc.) machines being operable directly at a construction site. Once on site, the components for the VR simulator can be assembled in a limited amount of time, such as within 30-45 minutes. Each of the construction equipment and/or site roles (e.g., operator, safety spotter, laborer, etc.) may have a pre-determined training courses that may progress from basic to advanced topics. Proficiency results may be collected at the end of each lesson and may be uploaded to a learning management system, which may track training courses, results, ratings, and/or qualifications for each trainee.

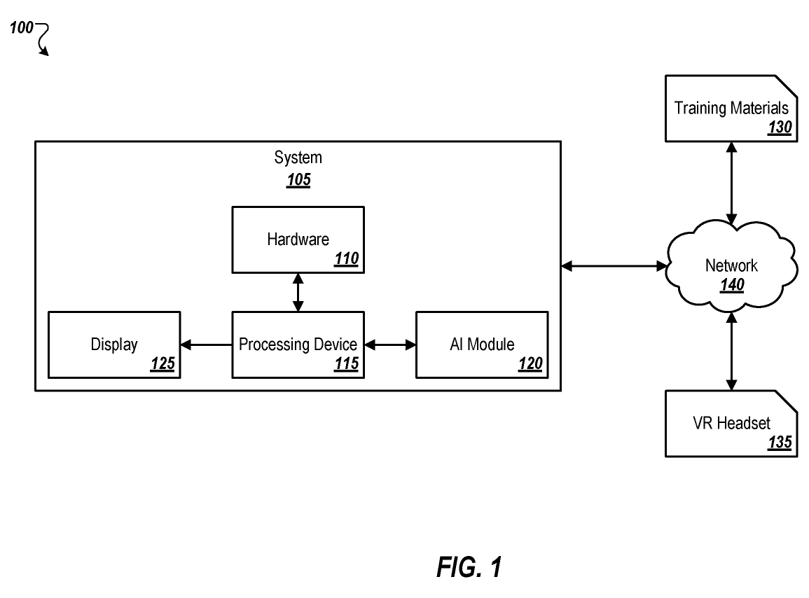

FIG. 1 illustrates a block diagram of an example environment 100 for a VR training simulator. The environment 100 may include a system 105 and a network 140. The system 105 may include hardware 110, a processing device 115, an artificial intelligence (AI) module 120, and a display 125.

The network 140 may function as a central communication medium that may enable data transmission between the system 105 (and/or components within the system 105, including the hardware 110, the processing device 115, the AI module 120, and the display 125) with training materials 130 and/or a VR headset 135. The network 140 may facilitate the exchange of data and signals that may be used to display and/or interact with a VR simulation environment, as described herein. In some instances, the network 140 may be a wireless network and/or a wired network to facilitate communications between the connected elements in the system 105.

In some instances, the system 105 may be operable to provide hardware and software to a user, such that a user may interact with a virtual environment to perform one or more operations as part of a VR training simulation. The system may facilitate user interactions with the hardware 110 to cause changes in the virtual environment according to the user interactions and as part of a training simulation associated with an operation. As such the system 105 may facilitate a user being trained in a virtual reality environment to perform operations and based on the user’s performance in the VR training simulation, the user may receive a report that may denote the user’s proficiencies relative to performing the operation.

In some instances, the hardware 110 may correspond to an operation, such as an operation for training in a virtual simulator, as described herein. For example, the hardware 110 may include various hand controls and/or foot controls that may be used to provide inputs to an operation. The operation may include one or more of a fork lift operation, an excavator operation, a dozer operation, an articulated dump truck operation, an off-road truck operation, and/or a wheel loader operation. As such, the hardware 110 may include hand controls and/or foot controls for controlling an excavator, hand controls and/or foot controls for controlling a dozer, and so forth. Hand controls can comprise, for example and without limitation, joysticks, wheels, and/or gear shift controls, and foot controls can comprise, for example and without limitations, pedals for braking, throttle control, and/or transmission control. In some instances, the operations may vary based on different iterations of the machinery associated with the operation. For example, the excavators may be between 25 ton and 50 ton excavators (e.g., where each different iteration may have a unique VR training simulator), the dozers may be between 60 horsepower and 200 horsepower dozers, the dump trucks and/or off-road trucks may be between 30 ton and 50 ton trucks, and/or the wheel loaders may be between 100 horsepower and 200 horsepower wheel loaders.

Alternatively, or additionally, the training simulator may be an operation that may be adjacent to one or more of the operations described herein. For example, the adjacent operation (e.g., the training simulation) for a user may include a spotter training simulation, where the user may learn positioning associated with one of the machines in the operations. In another example, the adjacent operation may include lifting training and/or rigging training that may be used with a machine (e.g., that may be included in another operation). In another example, the adjacent operation may include loading of equipment for transport and/or transport of equipment operations.

In some instances, the hardware 110 may individually correspond to an operation, where there may be multiple various operations that may be utilized in the environment 100 for VR training simulations. For example, first hardware may correspond to a first operation, second hardware may correspond to a second operation, and so forth. Alternatively, or additionally, a particular hardware of the hardware 110 may be used for multiple operations. For example, first hardware may be used with a first operation and with a second operation, second hardware may be used with a third operation and a fourth operation, and so forth. In such instances, the system 105 may be configured to train a user on different operations (and/or on different equipment) by altering/changing the hardware 110 (e.g., swapping a first hardware for a second hardware in the system 105) and/or updating the training simulation (e.g., updating the software from a first operation to a second operation) in the processing device 115 as desired for a particular operation.

In some instances, the hardware 110 may be operable to generate an input that may be transmitted to the processing device 115 via a connection (e.g., a USB connection) between the hardware 110 and the processing device 115. The input may be based on a user interaction with the hardware 110. For example, a user interaction with a hand control of the hardware 110 may generate an input that may be transmitted to the processing device 115 via the connection between the hardware 110 and the processing device 115. The processing device 115 may transmit the input to the virtual environment operating within the VR headset 135 via the network 140, which may include one or more of Wi-Fi, Ethernet, and/or Bluetooth. Within the virtual environment, the input (obtained from the processing device 115 and corresponding to the user interaction) may be recognized as a hand control input from the hardware 110 and may cause a resulting action to a simulated machine within the virtual environment displayed in the VR headset 135. For example, in instances in which the VR training simulator is an excavator simulation, a forward movement of a joystick (e.g., the hardware 110) may send a signal to the processing device 115, which may be transmitted to the VR headset 135 via the network 140, and the resulting action may be to extend a virtual excavator arm in a manner corresponding to the forward movement of the joystick.

In some instances, the hardware 110 may be sized and shaped to be conveyed in a one-person capable, portable container, such as a hardened protective case, a case with wheels, a hard-frame softshell case, and so forth. In some instances, the hardware 110 may fold or otherwise condense such that the hardware 110 may fit within a portable container. Alternatively, or additionally, the hardware 110 may be sized such that the hardware 110 may fit within a portable container without any condensing. In some instances, the hardware 110 may be weighted such that the hardware 110 may be transported by a single person. In these and other instances, the hardware 110 and/or the system 105 may be transported to various locations (e.g., work sites, where real equipment corresponding to the training equipment may be located) for users thereof (e.g., trainees) to train on. In such instances, the users may be operable to train using the system 105 at or near a work site and/or the users may not be required travel The VR headset 135 may be a headset designed for the VR training simulator, which may include one or more characteristics and/or visual indicators that may be applicable to a particular operation and/or the VR training simulator. Alternatively, or additionally, the VR headset 135 may be a commercially available headset, such as an APPLE VISION PRO™, META QUEST™, and/or other commercially available VR headsets. In some instances, the virtual environment may be interacted with by a user using the hardware 110. For example, the hardware 110 may include a computing device that may be configured to simultaneously display the virtual environment and/or actions performed therein and/or perform actions relative to the virtual environment, including at least recording actions and/or operations performed in the virtual environment.

In some instances, the VR headset 135 may be operable to direct the AI module 120 to provide various interactions with the user while the user may be performing operations within the virtual environment. Alternatively, or additionally, the VR headset 135 may be configured to operate the AI module 120. Alternatively, or additionally, the processing device 115 may direct the AI module 120 and/or operate the AI module 120 independently as described, or in concert with the VR headset 135.

In some instances, the AI module 120 may be configured to interact with the user while the user is using the system 105 as a VR training simulator. For example, in some instances, the AI module 120 may operate other equipment and/or may perform other operations in tandem with the user of the system 105. For example, the AI module 120 may operate a dump truck to be filled by the user of the system 105, while the user is training to use an excavator. In some instances, the AI module 120 may be configured to work in tandem with the user, to simulate obstacles for the user to avoid (e.g., warehouse workers or construction site workers around which the user must navigate and/or avoid contacting during machine operation), and/or to provide helpers or partners with which the user needs to work with to complete a task.

In another example, the AI module 120 may provide feedback to the user as part of the operation being performed by the user. For example, in instances in which the user is operating machine that may benefit from a spotter (to help guide the operation of the machine), the AI module 120 may provide spotter feedback to the user that may be the same or similar as spotter feedback in a non-training operation.

In another example, the AI module 120 may be operable to facilitate question and answer responses to the user of the system 105 and/or provide feedback to the user. For example, as the user performs operations in the virtual environment of the system 105 and the user has questions, the user may submit questions to the AI module 120 during the operation and the AI module 120 may be operable to respond to the questions. Alternatively, or additionally, the AI module 120 may be operable to submit questions to the user, where the questions may be related to the operation (e.g., a knowledge check associated with various aspects of the operation) being performed by the user in the VR training simulator, and the AI module 120 may be operable to provide feedback related to the answers submitted by the user. Alternatively, or additionally, the AI module 120 may be operable to submit feedback to the user based on the performance of the user in the VR training simulator. For example, in response to the user making a mistake in the VR training simulator, the AI module 120 may illustrate to the user the mistake, a reason why it was a mistake, and/or corrective actions to avoid the mistake in the future.

In these and other instances, the AI module 120 may be trained using the training materials 130, which may include manuals, training courses, videos, descriptions, and/or other materials associated with a particular operation, such that the AI module 120 may be operable to perform the particular operation and/or provide feedback on the performance of the particular operation. In some instances, as the AI module 120 is trained using the training materials 130 as described, human input (e.g., from a skilled and/or certified operator or instructor with experience on the desired machine) may provide feedback to the AI module 120 to confirm or adjust the learning of the AI module 120 relative to the operations. For example, in instances in which the AI module 120 provides incorrect feedback and/or improperly performs an action, the human input may correct the mistake by the AI module 120 to provide another learning method to the AI module 120.

In some instances, the AI module 120 and/or an associated reporting module (not illustrated) may generate a report based on the performance of the user relative to the operation in the virtual environment. The report may provide an indication of the skill of the user relative to the operation and/or an indication of performance relative to an expectation of performance of the operation. In some instances, a certificate of qualification may accompany the report that may provide an indication that a particular user may be qualified to perform operations using equipment corresponding to the VR training simulator. Alternatively, or additionally, the certificate of qualification may indicate a degree of qualification the particular user may have relative to the performed operations. For example, in instances in which the VR training simulator determines the particular user is qualified in four out of five tasks associated with particular equipment and/or that the particular user may be approximately ninety percent proficient in a particular task, the certificate of qualification may indicate such results.

In some instances, the report may be separated into various tasks, each associated with the operation. For example, tasks that may be included in the report may include pre-operation tasks, safety tasks, operational tasks, and/or skill tasks. The pre-operation tasks may include an inspection associated with the equipment and/or the operational environment. The safety tasks may include one or more safety policies that may be individually associated with the equipment to be used and/or operation of the equipment in a particular environment. The operational tasks may include one or more actions that the user may perform using the equipment. The skill tasks may include smoothness of operation, timely performance of the operation, proper interaction with the environment and/or other users, and/or handling of complex movements (e.g., moving an excavator while adjusting a bucket of the excavator). In some instances, the report may be a summation of a score given to the performance by the user of each task in the operation, and may assess the users performance relative to smoothness, precision, and/or proficiency of the operation.

In these and other instances, one or more weights may be applied to the tasks that are included in the operation (e.g., in instances in which the operation includes multiple steps or tasks, a weight may be applied to each step/task). The weights may be indicative of an importance associated with each task relative to the overall performance of the operation. For example, in instances in which a first task of an operation is of lower importance relative to a second task of the operation, the first task may receive a first weight and the second task may receive a second weight, where the second weight may be greater than the first weight. A combination of the tasks performed, a weight associated with the tasks performed, and/or a score individually assigned to the tasks performed, an overall performance of the operation by the user may be assessed and included in the report. In some instances, the weights may be adjusted based on the operation and/or the tasks performed. Alternatively, or additionally, the weights can be manually tuned based on a desired result of the VR training simulation. For example, in instances in which a trainer is seeking high performance relative to a particular task in an operation, the particular task may be assigned a greater weight than might otherwise normally be assigned to the particular task.

In some instances, the VR headset 135 may be operable to duplicate the display of the VR headset 135 on the display 125. For example, as the user in the operation views the environment associated with the VR training simulation in the VR headset 135, the same view of the environment may be duplicated on the display 125 for viewing by others, such as a trainer, a skilled operator, other trainees, etc. In some instances, the VR headset 135 may include a screen duplication feature that may facilitate the duplication of the display of the VR headset 135 to the display 125. For example, the VR headset 135 may include a “cast” or “screen mirroring” functionality that may utilize wireless capabilities to duplicate the display of the VR headset 135 to the display 125. Alternatively, or additionally, the display 125 may be utilized to display information associated with the operation. For example, the display 125 may be used to display: the scoring rubric that may be used to determine the user’s performance of the operation, training materials and/or important aspects to remember regarding the operation, and/or the results of the user in performance of the operation.

Modifications, additions, or omissions may be made to the environment 100 without departing from the scope of the present disclosure. For example, in some instances, second hardware may be included in the system 105 that may be utilized by a second user to perform a second operation in the VR training simulation. In some instances, the second operation may be complementary and/or related to the operation. For example, the second user of the system 105 (e.g., using the second hardware) may operate a dump truck (e.g., a second operation) to be filled by the user of the system 105 (e.g., using the hardware 110), while the user is training to use an excavator (e.g., a first operation). In some instances, the user and the second user may be operable to interact with one another in the VR training simulation. In instances in which a second user is in the VR training simulation and performing tasks associated with a second operation, the second user may receive a second report associated with their performance of tasks associated with the second operation, where the second report may include weights associated with the tasks corresponding to the second operation.

In some instances, the performance of the operation by the user may be stored in a local storage device (e.g., in a local server, database, and/or other storage device) that may be included in the system 105. Alternatively, or additionally, the performance of the operation may be stored in a remote storage device (e.g., a cloud-based storage device, a remote accessible server, etc.) that may be remote from the system 105. In these and other instances, the performance of the operation by the user may be viewed after the performance thereof for various purposes, such as a review of the simulation (e.g., a review of the operation and/or related environment to ensure accuracy and/or fairness of the simulation), a review of the performance by the user (e.g., a self-review to learn from mistakes), a review of the performance by a trainer or instructor (e.g., a review to learn different methods of teaching and/or focus areas associated with the operation), and so forth. Any of the reviews of the simulation may be performed either with the system 105, such as using the display, or remote from the system 105 and/or the environment 100, such as by accessing the cloud storage device and reviewing the stored performance of the operation.

Alternatively, or additionally, the designations of different elements in the manner described is meant to help explain concepts described herein and is not limiting. Further, the environment 100 may include any number of other elements or may be implemented within other systems or contexts than those described. For example, any of the components of FIG. 1 may be divided into additional or combined into fewer components.

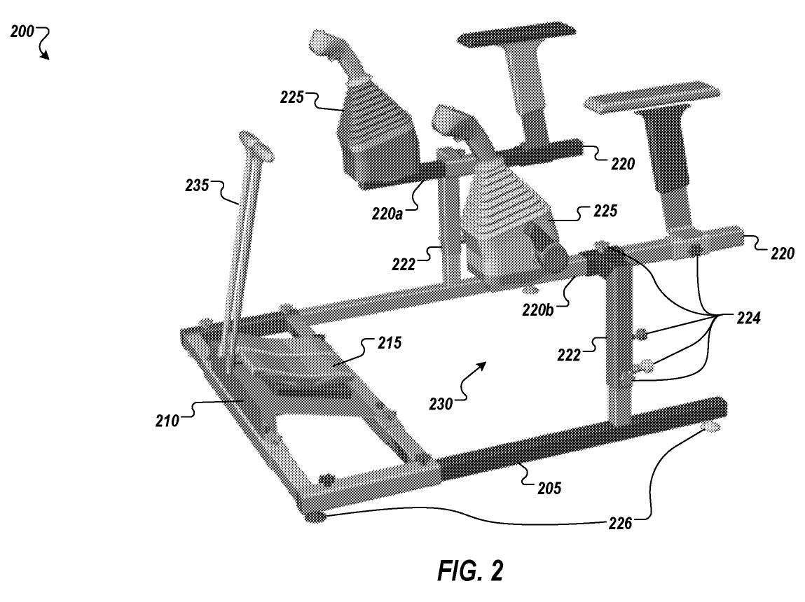

FIG. 2 illustrates a perspective view of an example VR training simulator 200. The VR training simulator 200 may include a base assembly 205, a pedal assembly 210, a pedal module 215, control arm assemblies 220, one or more vertical supports 222, mechanical fasteners 224, control modules 225, one or more adjustable feet 226, and a steering module 235. The VR training simulator 200 may be the same or similar as the hardware 110 described relative to FIG. 1. For example, the VR training simulator 200 may be the equipment used with a VR headset and/or a simulated environment to provide a simulated training experience for one or more users.

In some instances, the base assembly 205 may form a base portion of the VR training simulator 200, where other components may be attached to the base assembly 205 to form the VR training simulator 200. The base assembly 205 may be arranged to form a seating bay 230 within the VR training simulator 200. The seating bay 230 may be operable to receive a non-dedicated chair, where the chair may not be affixed to any portion of the VR training simulator 200. For example, the seating bay 230 may be configured to receive various commercial and/or personal chairs of various sizes, where the VR training simulator 200 (and/or components of the VR training simulator 200) may be adjusted as desired such that the seating bay 230 may accommodate a chair. The chairs may include armless chairs, fixed height chairs, adjustable height chairs, and/or any other similarly available chairs.

In some instances, the pedal assembly 210 may be configured to couple to the base assembly 205. The pedal module 215 may be configured to couple to the pedal assembly 210 and may include a fore-and-aft coupling that may allow selective positioning of the pedal module 215 relative to the seating bay 230. As such that the pedal module 215 may be repositioned relative to the seating bay 230 and may be adjusted for users having varying heights. In some instances, the pedal module 215 may provide inputs to the VR training simulator 200 that may include accelerator functions, decelerator functions, braking functions, and/or steering functions corresponding to the particular construction equipment being simulated in the VR training simulator 200.

In some instances, the pedal module 215 may correspond to a particular equipment that may be used for training in the VR training simulator 200. In instances in which the VR training simulator 200 may be used for training using a second equipment where the pedals in the second equipment may differ from pedals in the particular equipment, the pedal module 215 may be interchanged such that the pedal module 215 may correspond with the second equipment. The pedal assembly 210 may include an expandable platform that may be configured to receive the pedal module 215 (or variations thereof, as described) that may correspond to different classes of construction equipment.

In some instances, the control arm assemblies 220 may comprise a right control arm assembly 220a and/or a left control arm assembly 220b. Each of the control arm assemblies 220 may be adjustable relative to the base assembly 205, which may be used to provide comfort for the user of the VR training simulator 200. In some instances, the control modules 225 may be coupled to the control arm assemblies 220. The adjustment of the control arm assemblies 220 may be used to arrange the control modules 225 to be an arm’s length from the user of the VR training simulator 200, where each of the control arm assemblies 220 may be individually adjusted as desired. In some instances, the control arm assemblies 220 may include the vertical supports 222 that may facilitate a vertical adjustment of the control modules 225. The vertical supports 222 may include a number of pre-determined discrete height positions to which the control modules 225 may be adjusted. Alternatively, or additionally, the vertical supports 222 may adjusted to any vertical height, such as by tightening a fastener to the control arm assemblies 220 once a preferred height has been obtained.

In some instances, the control modules 225 may be positionally adjusted relative to the control arm assemblies 220 to further refine that location and/or comfort of use of the control modules 225 for the user. The control modules 225 may be removably coupled to the control arm assemblies 220 using the mechanical fasteners 224 and/or standardized electrical connectors, which may be tool-less, such that the control modules 225 associated with first construction equipment may be easily changed to be associated with second construction equipment, based on the training to be performed using the VR training simulator 200. For example, the mechanical fasteners 224 may include thumb screws, knobs, and/or other mechanical fasteners that may be operated without using tools. In another example, the electrical connectors may include USB ports, coaxial cable ports, serial ports, and/or other similar standardized electrical connectors.

In some instances, the mechanical fasteners 224 may pass through an outer tubing and engage an inner tubing of various components of the VR training simulator 200 to secure the outer tubing relative to the inner tubing. For example, the mechanical fasteners 224 may be threaded and may screw through a complementary threaded outer tubing of the vertical supports 222 to tighten against an inner tubing of the vertical supports 222. In such instances, the mechanical fasteners 224 may hold the outer tubing in place relative to the inner tubing by threading through the hole in the outer tubing and applying a force to the inner tubing.

Alternatively, or additionally, the various components of the VR training simulator 200 operable to receive the mechanical fasteners 224 (e.g., the base assembly 205, the control arm assemblies 220, the vertical supports 222, etc.) may include complementary holes to receive the mechanical fasteners 224. For example, the outer tubing of the vertical supports 222 may include a first hole to receive the mechanical fasteners 224 and the inner tubing of the vertical supports 222 may include one or more holes such that the outer tubing of the vertical supports 222 may be adjusted relative to the inner tubing thereof, until the holes of the outer tubing align with the holes of the inner tubing and the mechanical fasteners 224 may secure the desired position. In these and other instances, there may be one or more holes on the outer tubing and/or on the inner tubing, such that adjustments to the components of the VR training simulator 200 may be made to a desired position and may be secured using the mechanical fasteners 224.

In some instances, the base assembly 205 may include the adjustable feet 226 that may be tunable to level the VR training simulator 200 in an uneven setting. For example, in instances in which the VR training simulator 200 is deployed on a floor that is uneven, the adjustable feet 226 may be adjusted such that the VR training simulator 200 may be level or substantially level on a non-level surface. In some instances, the adjustable feet 226 may be threaded, such that a rotation of the adjustable feet 226 may change the length thereof relative to the base assembly 205. Alternatively, or additionally, the adjustable feet 226 may include mechanisms other than a threaded screw mechanic by which the adjustable feet 226 may level the VR training simulator 200 relative to a surface on which it may be located. For example, the adjustable feet 226 may include a hydraulic system, an air ballast system, and/or other mechanisms to provide leveling to the VR training simulator 200 via the adjustable feet 226.

In some instances, the control modules 225 may be configured for use with a particular construction equipment. In instances in which a user of the VR training simulator 200 desires to change the simulation from a first construction equipment to a second construction equipment, the control modules 225 may be modified accordingly, which may include interchanging the control modules 225 that may be associated with a first class of construction equipment to be associated with a second class of construction equipment. For example, the control modules 225 may be associated with a dump truck and in response to the user thereof changing the VR training simulator 200 for an excavator simulator, the control modules 225 may be interchanged to be associated with an excavator.

In some instances, the VR training simulator 200 may be disassembled into various components (e.g., at least the base assembly 205, the pedal assembly 210, the pedal module 215, the control arm assemblies 220, and the control modules 225) such that the disassembled VR training simulator 200 may be stored and/or transported in a portable carrying case. In some instances, the size, shape, and or weight of the disassembled VR training simulator 200 (and/or the portable carrying case) may be such that a single person may be operable to transport it.

In some instances, the steering module 235 may provide a steering function within the VR training simulator 200. As illustrated, the steering module 235 may include one or more levers that may correspond to a particular construction equipment steering mechanism. It will be appreciated that other types of steering devices may be used with the VR training simulator 200, such as a steering wheel. In some instances, the levers (as illustrated) may correspond to the operation of the pedal module 215 where the operation of the levers may coincide with the operation of the pedal module 215. In such instances, the levers may be affixed (e.g., screwed in) to the pedal module 215. Alternatively, or additionally the levers may operate independent of the pedal module 215, and in such instances, the levers may be coupled to the base assembly separately from the pedal module 215. In these and other instances, the pedal module 215, the control modules 225, and/or the steering module 235 may be reconfigurable to match the layout that may be present in the corresponding particular construction equipment.

Modifications, additions, or omissions may be made to the VR training simulator 200 without departing from the scope of the present disclosure. For example, the designations of different elements in the manner described is meant to help explain concepts described herein and is not limiting. Further, the VR training simulator 200 may include any number of other elements or may be implemented within other systems or contexts than those described. For example, any of the components of FIG. 2 may vary in appearance and/or functionality based on the particular operations in which the VR training simulator 200 may be used.

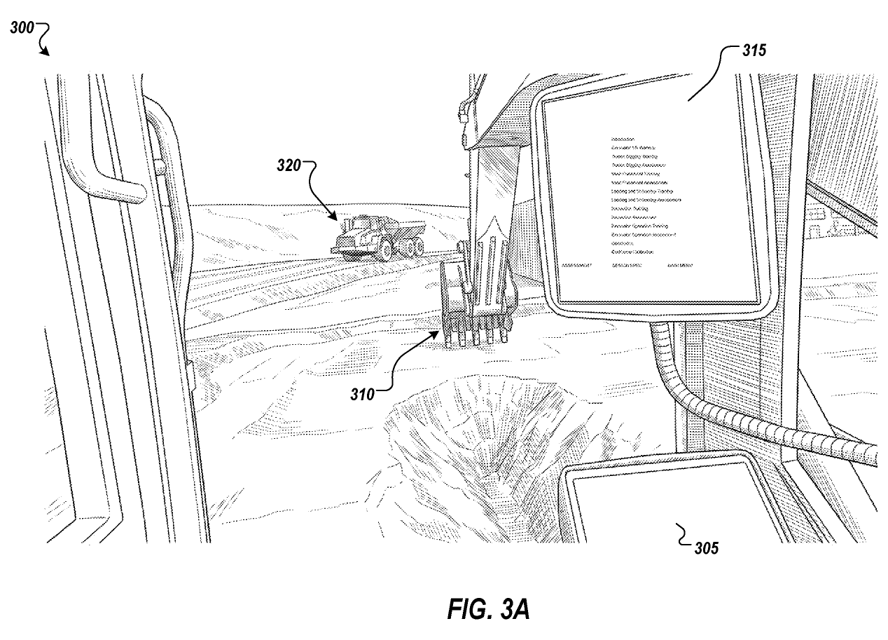

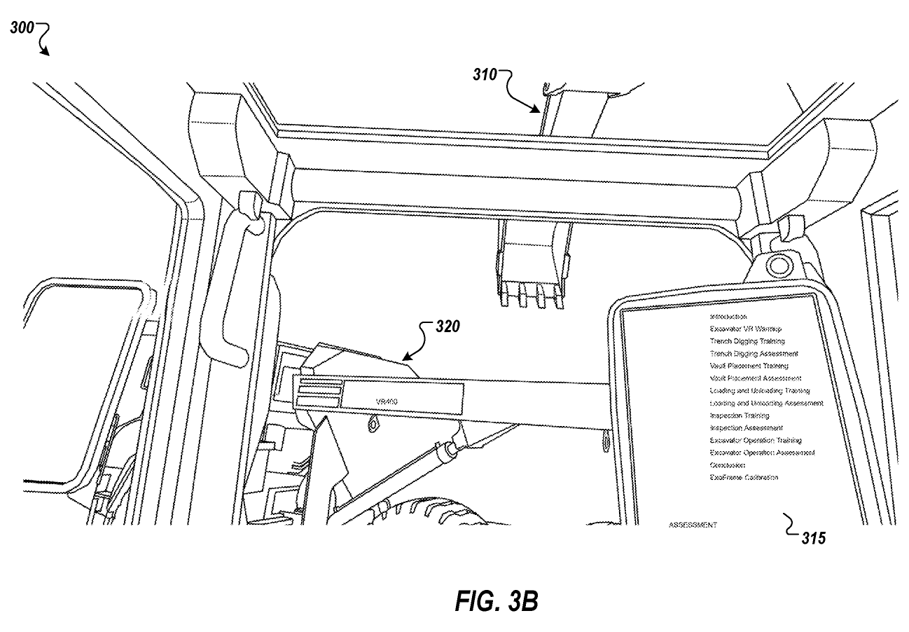

FIGS. 3A and 3B illustrate a first-person perspective view of an example VR training simulator environment 300. The VR training simulator environment 300 may include a virtual display of a training environment, training equipment, and/or associated displays, controls, and/or other similar objects that may be located in the VR training simulator environment 300. In some instances, a VR display 305 may be viewed within the VR training simulator environment 300. The VR display 305 may be the same or similar to a display that may be located in real equipment that corresponds to a first operation 310 in the VR training simulator environment 300. In some instances, the VR display 305 may be used to interact with and/or display information associated with the first operation 310 in the VR training simulator environment 300.

In some instances, as a user performs operations in the VR training simulator environment 300 associated with the first operation 310, a second operation 320 may occur simultaneously within the VR training simulator environment 300. In such instances, the second operation 320 may be performed by a second user, where a first user may control the first operation 310 and may interact with the second user and the second operation 320. Alternatively, or additionally, the second operation 320 may be performed by an artificial intelligence, such as the AI module 120 of FIG. 1. In such instances, the AI may interact with the user of the first operation 310 to facilitate a training simulation for the first user within the VR training simulator environment 300.

In some instances, the VR training simulator environment 300 may include a training display 315 that may provide instructions and/or feedback to the user within the VR training simulator environment 300. For example, the training display 315 may provide a display of different operations and/or techniques that may be tested within the VR training simulator environment 300. In some instances, the training display 315 may provide a sequence of operations that a user of the VR training simulator environment 300 may perform. Alternatively, or additionally, the training display 315 may provide an indication of a current status of the user within the VR training simulator environment 300. For example, as operations are performed in the VR training simulator environment 300, the training display 315 may provide an indication of the completed operations. In some instances, the training display 315 may provide feedback associated with the performance of operations within the VR training simulator environment 300. For example, a training supervisor may provide feedback via the training display 315 to the user thereof, and/or may include additional instructions and/or an assessment of performance to the user.

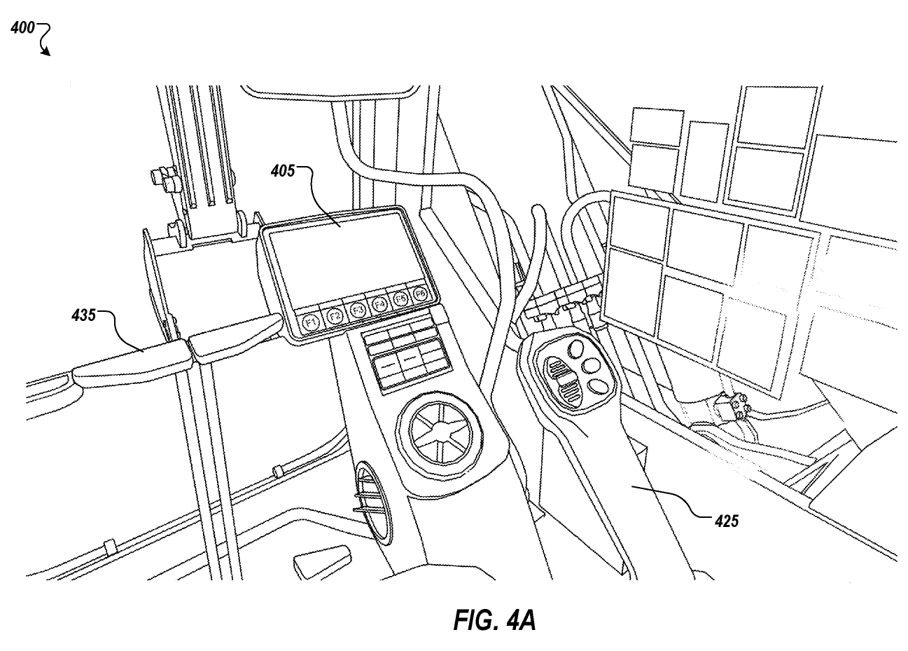

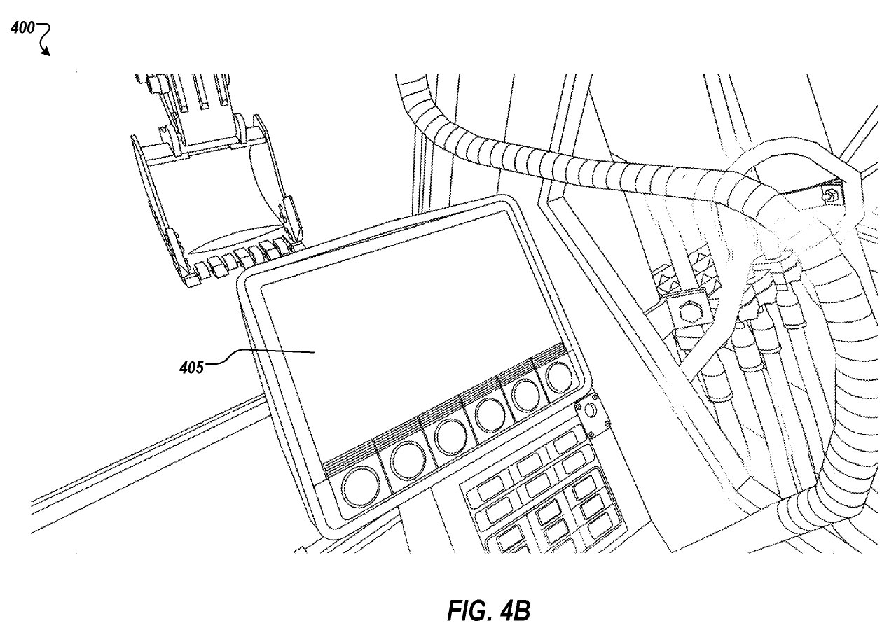

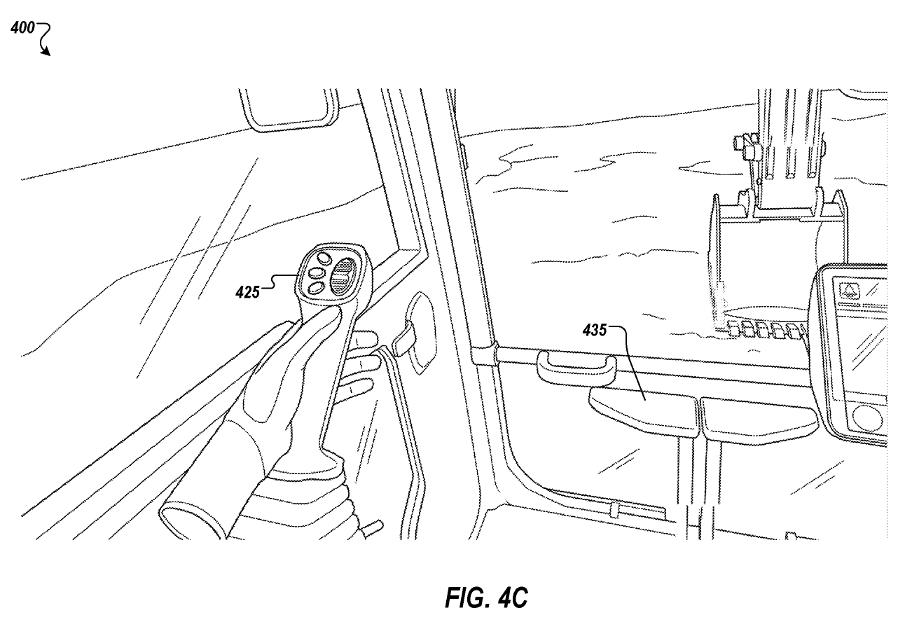

FIGS. 4A, 4B, and 4C illustrate a first-person perspective view of an example VR training simulator environment 400. The VR training simulator environment 400 may be the same or similar to the VR training simulator environment 300, and may include a virtual display of a training environment, training equipment, and/or associated displays, controls, and/or other similar objects that may be located in the VR training simulator environment 400.

As illustrated in FIG. 4A, the VR training simulator environment 400 may include a VR display 405 that may be the same or similar as a display that may be present in the VR training simulator environment 300. The VR display 405 may vary based on the equipment that is being simulated. For example, the VR display 305 may differ from the VR display 405 as the operations performed in the VR training simulator environment 300 may differ from the operations performed in the VR training simulator environment 400.

The VR training simulator environment 400 may include a control module 425 and/or a steering module 435, which may correspond to the operation of the VR training simulator environment 400. The control module 425 and/or the steering module 435 may be the same or similar as the control module 225 and the steering module 235 of FIG. 2, respectively.

FIG. 4B illustrates another example of the VR display 405. In some instances, the VR display 405 may include various pages that may be used to interact with the operations performed in the VR training simulator environment 400. Alternatively, or additionally, there may be multiple instances of the VR display 405 in the VR training simulator environment 400, where each of the VR displays 405 may provide different information and/or control within the VR training simulator environment 400.

FIG. 4C illustrates another example of the control module 425 and the steering module 435. As illustrated, the VR training simulator environment 400 may display a corresponding virtual hand to interact with the control module 425. As such, the VR training simulator environment 400 may provide a more realistic simulation environment, where the user thereof may have a visualization of their own interactions (via the virtual hand) with the VR training simulator environment 400, including at least the control module 425.

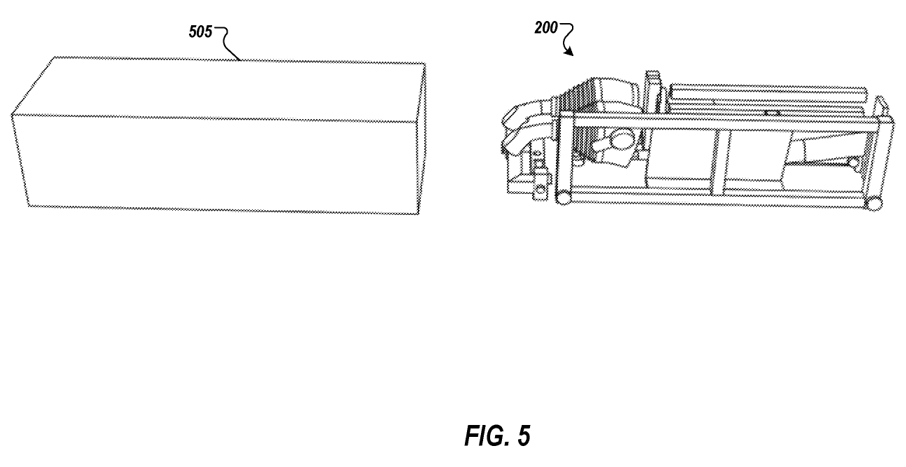

FIG. 5 illustrates a perspective view of the VR training simulator 200 and a portable carrying case 505 for storage and transport of the simulator components. As illustrated, the VR training simulator 200 is in a disassembled and condensed configuration suitable for placement within the portable carrying case 505, thereby facilitating portability of the simulator between various locations, such as offices, training rooms, and/or work sites where corresponding real equipment may be located.

In some instances, the portable carrying case 505 may be dimensioned and shaped to receive the disassembled components of the VR training simulator 200, including the base assembly, the pedal assembly, the pedal module, the control arm assemblies, the control modules, and the steering module as described with respect to FIG. 2. The portable carrying case 505 may be a portable carrying case, such as a duffel bag, or as a portable box such as a plastic bin having a hinged lid or a removable lid. In some instances, the portable carrying case 505 may be hardened to provide protective containment for the internal components of the VR training simulator 200 during transit. Alternatively, or additionally, the portable carrying case 505 can include a softer enclosure configured to conform to the condensed profile of the disassembled simulator. The portable carrying case 505 may also comprise protective padding to protect the VR training simulator 200 during transit.

In some instances, the size, shape, and weight of the portable carrying case 505 with the disassembled VR training simulator 200 contained therein are configured such that a single person can convey the portable carrying case 505 between locations. The modular construction of the VR training simulator 200 may allow the individual frame components to be separated from one another, allowing the VR training simulator 200 to be condensed into a volume that fits within the interior of the portable carrying case 505. The removable coupling between the control modules and the control arm assemblies, together with the fore-and-aft coupling of the pedal module to the pedal assembly, facilitates disassembly of the VR training simulator 200 into discrete components that can be arranged within the portable carrying case 505 for compact storage.

In some instances, the VR training simulator 200 can be reassembled from the components stored within the portable carrying case 505 at a destination location within a limited timeframe, such as approximately 30 to 45 minutes. Additionally, the portability afforded by the portable carrying case 505 may enable the VR training simulator 200 to be transported to construction sites, warehouses, or other work environments where users can train at or near the location of corresponding real-world equipment, thereby facilitating a transition from simulated training to real-world operation upon completion of training sessions using the VR training simulator 200.

In some instances, the portable carrying case 505 may include one or more handles (not illustrated) or other mechanisms that may be used to lift, move, or otherwise handle the portable carrying case 505. Alternatively, or additionally, the portable carrying case 505 may include one or more sets of wheels (not illustrated) that may be used to convey the VR training simulator 200 when disposed within the portable carrying case 505. For example, the portable carrying case 505 may include a handle at a first end and may include a set of wheels on a second end opposite the first end, such that a user may lift the portable carrying case 505 by the handle and may wheel the VR training simulator 200 using the portable carrying case 505 and the included attachments.

Modifications, additions, or omissions may be made to the case 505 without departing from the scope of the present disclosure. For example, the designations of different elements in the manner described is meant to help explain concepts described herein and is not limiting. Further, the case 505 may include any number of other elements or may be implemented within other systems or contexts than those described. For example, any of the components of FIG. 5 may vary in appearance and/or functionality based on the particular operations in which the case 505 may be used.

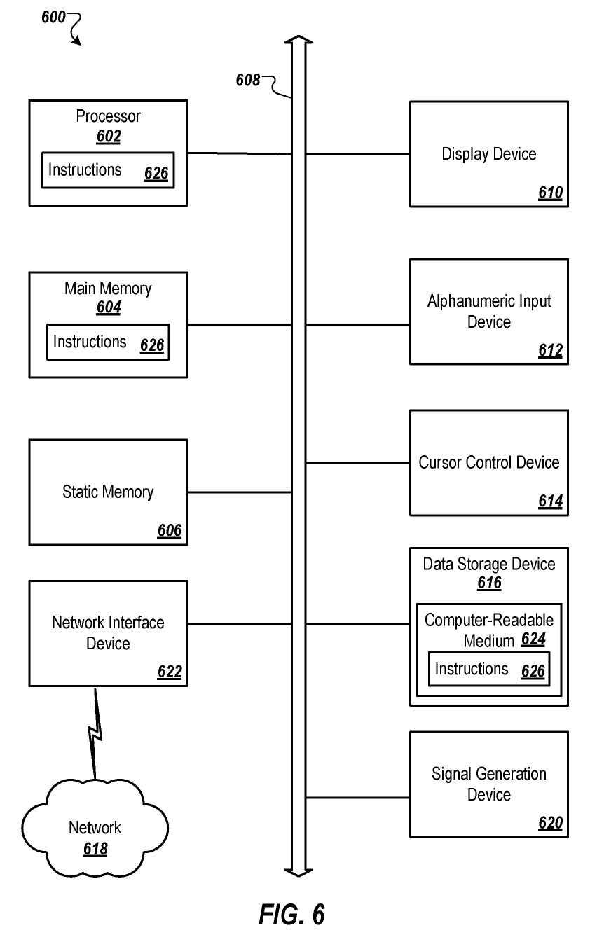

FIG. 6 illustrates an example computing device 600 within which a set of instructions for causing the machine to perform any one or more of the methods discussed herein may be executed. The computing device 600 may include a VR headset (as described herein), a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 600 can include a processing device 602 (e.g., a processor), a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

The processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one implementation, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over the network 618 via the network interface device 622.

While the computer-readable storage medium 624 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A system, comprising:
first hardware associated with a first operation, the first hardware configured to generate inputs based on a user interaction of a first user with the first hardware;
a virtual reality headset; and
a processing device to facilitate an interface between the first hardware and the virtual reality headset, wherein the virtual reality headset is operable to:
display a virtual environment for the first user to interact with using the inputs generated by the first hardware, the virtual environment corresponding to the first operation; and
cause a report to be automatically generated associated with a performance of the first user relative to the first operation in the virtual environment.

2. The system of claim 1, further comprising:
second hardware associated with a second operation, the second hardware configured to generate second inputs based on a second user interaction of a second user with the second hardware; and
a second virtual reality headset, operable to:
display the virtual environment and actions corresponding to the second inputs via the second virtual reality headset, such that the first operation and the second operation are displayed in the virtual environment; and
cause a second report to be automatically generated associated with a performance of the second user relative to the second operation in the virtual environment.

3. The system of claim 2, wherein the first user and the second user interact with one another in the virtual environment.

4. The system of claim 2, wherein the first operation and the second operation include complementary interactions with each other.

5. The system of claim 1, wherein the first hardware is included in a plurality of hardware, where each of the plurality of hardware is individually associated with an operation.

6. The system of claim 1, wherein the virtual reality headset is further operable to:
integrate an artificial intelligence module into the virtual environment; and
direct the artificial intelligence module to interact with the first user corresponding to the first operation and the inputs.

7. The system of claim 6, wherein the artificial intelligence module is trained using manuals and training courses associated with at least the first operation.

8. The system of claim 6, wherein the artificial intelligence module is configured to interact with the first user in the virtual environment, the interaction comprising providing questions to the first user, providing commentary to the first user corresponding to the inputs, and providing feedback to the first user based on the inputs relative to the first operation.

9. The system of claim 1, wherein the report is generated based on performance of the first user in the virtual environment relative to the first operation.

10. The system of claim 9, wherein the performance is determined by applying one or more weights to various skills associated with the first operation based on an expectation of performance associated with the first operation.

11. The system of claim 1, wherein the first hardware is sized and shaped to be stored in a one-person capable portable container.

12. The system of claim 1, wherein the first operation is one of an excavator operation, a dozer operation, an articulated dumping operation, an off-road truck operation, or a wheel loader operation.

13. A system, comprising:
a modular frame assembly, comprising:
a base assembly defining a seating bay;
a pedal assembly coupled to the base assembly, the pedal assembly comprising a pedal module;
at least one control arm assembly coupled to the base assembly; and
equipment specific control modules coupled to the control arm assembly;
a virtual reality headset; and
a processing device communicatively coupled to the pedal module, the equipment specific control modules, and the virtual reality headset, wherein the virtual reality headset is configured to:
display a simulated environment within the virtual reality headset; and
obtain a user input from the pedal module and the equipment specific control modules and cause a corresponding operation to occur in the simulated environment.

14. The system of claim 13, wherein the equipment specific control modules are removably coupled to the at least one control arm assembly using tool-less mechanical fasteners and standardized electrical connectors to interchange the equipment specific control modules corresponding to different types of construction equipment.

15. The system of claim 13, wherein the at least one control arm assembly comprises a left control arm assembly and a right control arm assembly that are individually adjustable relative to the base assembly.

16. The system of claim 13, wherein the at least one control arm assembly comprises a vertical support having a plurality of discrete height positions to vertically adjust a height of the equipment specific control modules.

17. The system of claim 13, wherein the pedal assembly is mounted to the base assembly with a fore-and-aft adjustable coupling that permits selective positioning of the pedal module relative to the seating bay.

18. The system of claim 13, wherein the pedal assembly comprises an expandable pedal platform configured to selectively receive different pedal modules having pedal arrangements corresponding to distinct classes of construction equipment.

19. The system of claim 13, wherein the modular frame assembly is disassemblable into a plurality of frame components sized and weighted for transport by a single person within a portable carrying case.

20. The system of claim 13, wherein the seating bay is dimensioned to receive a non-dedicated chair without the non-dedicated chair being permanently affixed to the base assembly.
